(19) United States
(12) Patent Application Publication
(10) Pub. No.: US 2025/0189369 A1
(43) Pub. Date: Jun. 12, 2025

(54) ANTI-SNEAK SHOT DETECTOR

(71) Applicants: Jianchang CHEN, Foshan City (CN); Guanxian LIANG, Foshan City (CN)

(72) Inventors: Jianchang CHEN, Foshan City (CN); Guanxian LIANG, Foshan City (CN)

(21) Appl. No.: 18/409,129

(22) Filed: Jan. 10, 2024

(30) Foreign Application Priority Data
Dec. 6, 2023 (CN) 2023233209370

(51) Int. Cl. G01J 1/44; G01J 1/02

(52) U.S. Cl. CPC G01J 1/44; G01J 1/0271

(57) ABSTRACT

The present invention relates to the technical field of privacy protection equipment and discloses an anti-sneak shot detector, comprising a housing mechanism, a main control circuit board, and infrared sensors, wherein a plurality of the infrared sensors are evenly distributed in the housing mechanism along a circumferential direction, the main control circuit board is accommodated in the housing mechanism and is respectively connected to the infrared sensors via signals, and on the housing mechanism and/or the main control circuit board are provided Indicators; and when an infrared sensor receives an infrared signal, an indicator in a direction of the infrared sensor responds accordingly. The present invention realizes automatic surrounding scanning of the environment to detect hidden cameras in the environment, and has better portability. And the present invention is suitable for people who often travel on business, women living alone, security personnel, and confidential institutions.

### TECHNICAL FIELD

The present invention relates to the technical field of privacy protection equipment, specifically an anti-sneak shot detector.

### BACKGROUND TECHNOLOGY

Some criminals will use hidden cameras to illegally obtain other people's privacy, business secrets and even state secrets. In order to detect and investigate hidden cameras, anti-sneak shot detectors have appeared in the existing technology.

One type of anti-sneak shot detectors can detect the presence of mobile communication signals, wireless local area network (WLAN) signals, and other communication signals to determine the existence of hidden cameras.

Another type of anti-sneak shot detectors includes red visible light emitters and/or infrared emitters, and infrared filters; after the red visible light emitters and/or infrared emitters are activated, red visible lights and/or infrared rays are emitted. When red visible lights and/or infrared lights are shone on outer lens of a hidden camera, strong reflection occurs and by observing the surroundings with infrared filters when intense red light reflection is detected, there may be a hidden camera at that location.

The above-mentioned anti-sneak shot detectors still have shortcomings: by visually observing red light reflections, it is greatly influenced by a user's vision, observational skills, and subjective factors, making it difficult to objectively judge the existence of hidden cameras. In addition, the aforementioned anti-sneak shot detectors cannot perform comprehensive environmental scanning and requires manual rotation for scanning, which is time-consuming and laborious, and prone to omissions.

In summary, how to provide an anti-sneak shot detector of a higher degree of automation has become an urgent problem to be solved.

### SUMMARY OF THE INVENTION

The present invention aims to provide an anti-sneak shot detector which can automatically scan around the environment to detect hidden cameras in the environment.

In order to achieve above purposes, the present invention offers following technical solutions: an anti-sneak shot detector, comprises a housing mechanism, a main control circuit board, and infrared sensors, wherein the housing mechanism at least comprises a light-transmitting ring portion capable of allowing infrared rays to pass through; a plurality of the infrared sensors are evenly distributed in the housing mechanism along a circumferential direction, receiving surfaces of the infrared sensors are aligned with the light-transmitting ring portion of the housing mechanism; the main control circuit board is accommodated in the housing mechanism and is respectively connected to the infrared sensors via signals; on the housing mechanism and/or the main control circuit board are provided indicators; and when an infrared sensor receives an infrared signal, an indicator in a direction of the infrared sensor responds accordingly.

In the above technical solutions, on the main control board are provided a plurality of detection indicator lights which are arranged in a quantity and at positions corresponding to the infrared sensors, on the housing mechanism are provided a plurality of detection indication light-transmitting positions which are arranged in a quantity and at positions corresponding to the detection indicator lights on the main control circuit board; and when an infrared sensor receives an infrared ray, a corresponding detection indicator light on the main control circuit board responds with instructions.

In the above technical solutions, the housing mechanism is embedded with a display screen, and the display screen is signally connected with the main control circuit board; and when an infrared sensor receives an infrared ray, the display screen responds with instructions in a direction of the infrared sensor.

In the above technical solutions, the main circuit board is further provided with a sound generator; and when an infrared sensor receives an infrared ray, the sound generator on the main control circuit board responds with instructions.

In the above technical solutions, the anti-sneak shot detector of the present invention further comprises a signal detection antenna, wherein the signal detection antenna are accommodated in the housing mechanism, and is signally connected to the main control circuit board, or the signal detection antenna is mounted on the main control circuit board; and when the signal detection antenna receives a communication signal, an indicator and/or the sounder generator responds with an indication correspondingly.

In the above technical solutions, the anti-sneak shot detector of the present invention further comprises a battery, wherein the battery is accommodated in the housing mechanism and is electrically connected to the main control circuit board; and the main control circuit board is also provided with a charging interface, and the charging interface penetrates from the housing mechanism.

In the above technical solutions, the main control circuit board is further provided with a start switch and a function switch respectively; the housing mechanism is embedded with a start button which is aligned with the start switch on the main control circuit board, and when the start button is pressed, the start switch is triggered; the housing mechanism is further embedded with a function button aligned with the function switch on the main control circuit board, and when the function button is pressed, the function switch is triggered.

In the above technical solutions, the main control circuit board is further provided with a plurality of function indicator lights; the housing mechanism are provided with a plurality of function indicator light-transmitting positions which are set in a quantity and positions corresponding to the function indicator lights on the main control circuit board.

In the above technical solutions, the housing mechanism comprises a mounting chassis and a cover assembly which are combined with each other from bottom to top; both the main control circuit board and the infrared sensors are fixed on the mounting chassis of the housing mechanism, and the cover assembly is covered on the mounting chassis to cover the main control circuit board and the infrared sensors; the cover assembly comprises the light-transmitting ring portion, a flange ring portion, and an inner cover portion which are sequentially arranged from outside to inside; display portions of the indicators are provided at where the inner cover portion locates; and the light-transmitting ring portion and the mounting chassis are mutually interlocked and fixed, the flange ring portion and the light-transmitting ring portion are mutually interlocked and fixed, and the inner cover portion is pressed onto the mounting chassis by the flange ring portion.

In the above technical solutions, at bottom portions of the housing mechanism are provided supporting legs and the supporting legs are deployable or retractable relative to the housing mechanism.

Compared to the prior art, the present invention has following beneficial effects: the anti-theft photo detector of the present invention has several infrared sensors evenly distributed along a circumferential direction in the housing mechanism, and on the main control circuit board are provided a plurality of detection indicators which are set in a quantity and positions corresponding to the infrared sensors, when any infrared sensor receives infrared rays, a corresponding detection indicator light on the main control circuit board responds, in such a way, automatic surrounding scanning of the environment is realized. Therefore, the present invention is used to detect hidden cameras in the environment and has good portability and is suitable for people who often travel on business, women living alone, security personnel and confidential agencies.

### BRIEF DESCRIPTION OF THE DRAWINGS

FIG. 1 is a perspective view of the present invention;

FIG. 2 is a first exploded view of the present invention;

FIG. 3 is a second exploded view of the present invention;

FIG. 4 is a perspective view when the present invention uses a display screen as an indicator.

FIG. 5 is a schematic view of the detection process when the present invention uses a display screen as an indicator.

The markups in the drawings are indicated as follows: 1—housing mechanism
11—mounting chassis;
111—supporting legs;
112—function button;
113—function indicator light-transmitting position;
12—cover assembly;
121—light-transmitting ring portion;
122—flange ring portion;
123—inner cover portion;
1231—detection indication light-transmitting position;
1232—start button;
1233—display screen;
2—main control circuit board;
21—detection indicator light;
22—sound generator;
23—start switch;
24—function switch;
25—function indicator light;
3—infrared sensor;
4—signal detection antenna; and
5—battery.

### SPECIFIC EMBODIMENTS

The technical solutions in the embodiments of the present invention will be clearly and completely described below with reference to the accompanying drawings in the embodiments of the present invention. Obviously, the described embodiments are only some, not all, of the embodiments of the present invention. Based on the embodiments of the present invention, all other embodiments obtained by those of ordinary skill in the art without creative efforts shall fall within protection scope of the present invention.

Some criminals use hidden cameras to illegally obtain other people's privacy, business secrets and even state secrets. How to detect hidden cameras has always been a problem that bothers people; hidden cameras are small in size and cannot be equipped with visible light fill lights. Therefore, hidden cameras use infrared emitters to fill the light; in addition, lenses of the hidden camera have a high reflectivity of infrared rays.

In view of the above characteristics, an embodiment of the present invention provides an anti-sneak shot detector, which is used to perform surrounding scanning of the environment to detect hidden cameras that may exist in the environment.

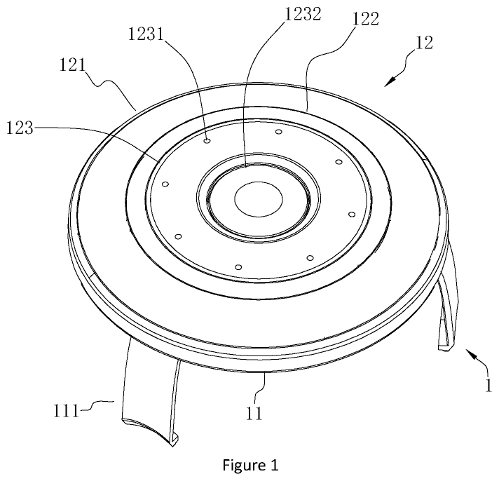

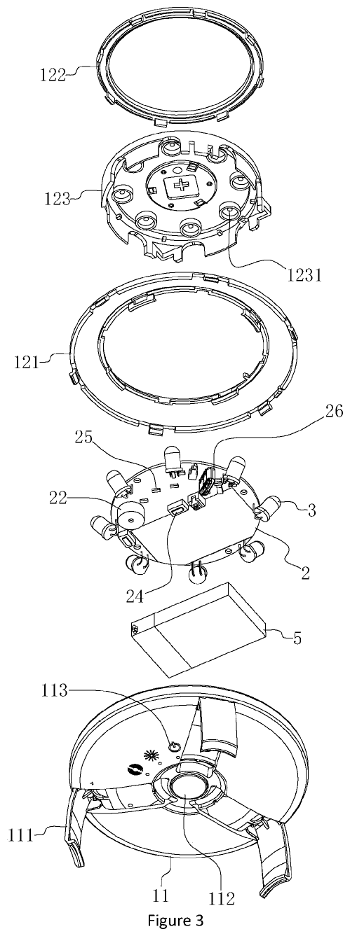

Please refer to FIGS. 1-5, an embodiment of the present invention provides an anti-sneak shot detector, comprising a housing mechanism 1, a main control circuit board 2, and infrared sensors 3, wherein the housing mechanism 1 is used to provide an accommodation foundation and a structural support foundation for the anti-sneak shot detector of the present embodiment; the main control circuit board 2 comprises a printed circuit board (PCB), which is equipped with an MCU such as a single-chip computer or an embedded chip; the infrared sensors 3 are specifically passive infrared sensors or active infrared sensors. No matter what type of the infrared sensors they are, when an infrared sensor receives an infrared ray, the level of the infrared sensor's own output changes, that is, when an infrared ray sensor 3 receives no infrared ray, the input of the infrared ray sensor is one level, and when an infrared ray sensor 3 receives an infrared ray, the input of the infrared ray sensor is another level, and the infrared sensors 3 are equipped with several levels of programmable detection sensitivity.

The housing mechanism 1 at least comprises a light-transmitting ring portion 121 capable of allowing infrared rays to pass through, in fact, the light-transmitting ring portion 121 is a transparent cover plate or a translucent cover plate.

A plurality of the infrared sensors 3 are evenly distributed in the housing mechanism 1 along a circumferential direction, receiving surfaces of the infrared sensors 3 are aligned with the light-transmitting ring portion 121 of the housing mechanism 1; the main control circuit board 2 is accommodated in the housing mechanism 1 and is respectively connected to the infrared sensors 3 via signals.

In the present embodiment, all the infrared sensors 3 are mounted on the main control circuit board 2 in a form of plug-ins to achieve electrical connection with the main control circuit board 2; furthermore, the housing mechanism 1 is further formed with slots for the infrared sensors 3 to be embedded therein to fix the infrared sensors.

On the housing mechanism 1 and/or the main control circuit board 2 are provided indicators; and when an infrared sensor 3 receives an infrared signal, an indicator in a direction of the infrared sensor 3 responds accordingly.

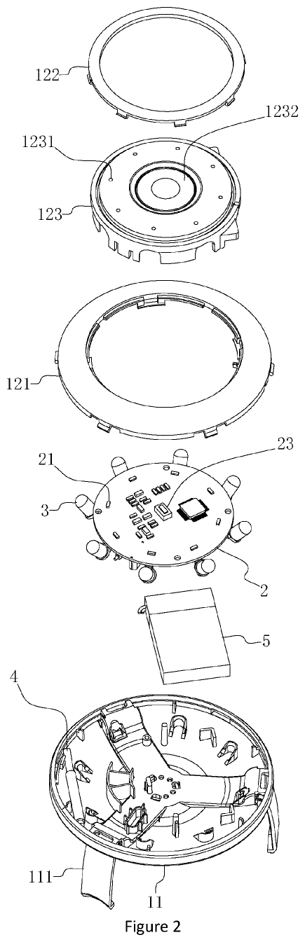

Please refer to FIGS. 1 and 2, in some possible embodiments, a specific technical solution of the indicators is as follows: on the main control board 2 are provided a plurality of detection indicator lights 21 which are arranged in a quantity and at positions corresponding to the infrared sensors 3, actually, the detection indicator lights 21 are LED lamp beads which are mounted on the main control circuit board 2 in a form of patches; on the housing mechanism 1 are provided a plurality of detection indication light-transmitting positions 1231 which are arranged in a quantity and at positions corresponding to the detection indicator lights 21 on the main control circuit board, actually, the detection indication light-transmitting positions 1231 are hole positions on the housing mechanism 1, in such way, the detection indicator lights penetrate through the surface of the housing mechanism 1; and when an infrared sensor 3 receives an infrared ray, a corresponding detection indicator light on the main control circuit board 2 responds with instructions, for example, it changes from an off state to an on state, from an on state to an off state, or flashes at a certain frequency.

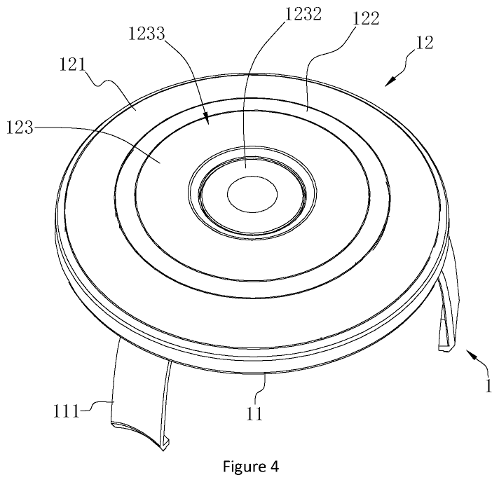

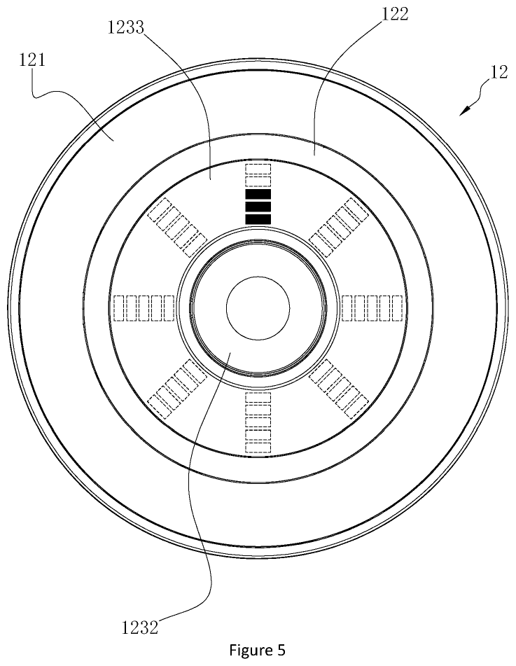

Please refer to FIGS. 4 and 5, in some other embodiments, a specific technical solution of the indicators is as follows: the housing mechanism 1 is embedded with a display screen 1233, and the display screen 1233 is signally connected with the main control circuit board 2; and when an infrared sensor 3 receives an infrared ray, the display screen 1233 responds with instructions in a direction of the infrared sensor 3; specifically, the display screen 1233 is a circular/annular liquid crystal display or LED display, and when an infrared sensor 3 receives infrared rays, the display screen 1233 displays a graphic in the direction of the infrared sensor 3, and can also display the corresponding intensity level according to the infrared intensity received by the infrared sensor 3.

Further, the main circuit board 2 is further provided with a sound generator 22, and the sound generator 22 comprises one of a buzzer, a universal speaker and an electric bell, and is mounted on the main control circuit board 2 in a form of plug-in; and when an infrared sensor 3 receives an infrared ray, the sound generator 22 on the main control circuit board 2 responds with instructions, such as a buzzer, voice prompt, and electric bell.

Further, the anti-sneak shot detector of the present embodiment further comprises a signal detection antenna 4, wherein the signal detection antenna 4 is accommodated in the housing mechanism 1, and is signally connected to the main control circuit board 2, or the signal detection antenna 4 is mounted on the main control circuit board 2, specifically, when the signal detection antenna 4 is an independent antenna, it is accommodated in the housing mechanism 1 and is signally connected to the main control circuit board 2, and when the signal detection antenna 4 is an onboard antenna, it is mounted on the main control circuit board 2; and when the signal detection antenna 4 receives a communication signal, an indicator and/or the sounder generator 22 responds with an indication correspondingly, and in the present embodiment, the signal detection antenna 4 receives wireless LAN signals from 1 MHz to 6.5 GHz.

Further, the main control circuit board 2 is further provided with a start switch 23 and a function switch 24 respectively, both the start switch 23 and the function switch 24 are micro switches, and both are mounted on the main control circuit board 2 in a form of plug-ins; the housing mechanism 2 is embedded with a start button 1232 which is aligned with the start switch 23 on the main control circuit board 2, and when the start button 1232 is pressed, the start switch 23 is triggered; the housing mechanism 1 is further embedded with a function button 112 aligned with the function switch 24 on the main control circuit board 2, and when the function button 112 is pressed, the function switch 24 is triggered.

Further, the main control circuit board 2 is further provided with a plurality of function indicator lights 25, and actually the function indicator lights 25 are LED lamp beads which are mounted on the main control circuit board 2 in a form of patches; the housing mechanism 1 are provided with a plurality of function indicator light-transmitting positions 113 which are set in a quantity and positions corresponding to the function indicator lights 25 on the main control circuit board 2, and actually function indicator light-transmitting positions 113 are hole positions on the housing mechanism 1, in such way, lights of the function indicator lights 25 are transmitted through the surface of the housing mechanism 1.

Specifically, the housing mechanism 1 comprises a mounting chassis 11 and a cover assembly 12 which are combined with each other from bottom to top, the mounting chassis 11 is an integrally formed disc-shaped engineering plastic half-shell, and the cover assembly 12 is a disc-shaped engineering plastic half-shell composed of multiple components; both the main control circuit board 2 and the infrared sensors 3 are fixed on the mounting chassis 11 of the housing mechanism 1, specifically, the main control circuit board 2 is fixed on the mounting chassis 11 of the housing mechanism 1 through screws or buckles, and the cover assembly 12 is covered on the mounting chassis 11 to cover the main control circuit board 2 and the infrared sensors 3; and it can be understood that the signal detection antenna 4 and the battery 5 are also fixed on the mounting chassis 11 of the housing mechanism 1 through screws or buckles.

Further, specifically, the cover assembly 12 comprises the light-transmitting ring portion 121, a flange ring portion 122, and an inner cover portion 123 which are sequentially arranged from outside to inside, wherein the light-transmitting ring portion 121, the flange ring portion 122 and the inner cover portion 123 are all made of engineering plastic materials, the light-transmitting ring portion 121 is an annular member made of transparent or translucent materials, which allow infrared rays to pass through, the flange ring portion 122 is also an annular member, and the inner cover portion 123 is a disc-shaped member; display portions of the indicators are provided at where the inner cover portion locates 123, namely, when the indicators are the detection indicator lights 21 on the main control circuit board 2, light-transmitting positions of the indicator are openings at the inner cover portion 123; when the indicators are the display screen 1233, it is embedded in the inner cover portion 123; and the light-transmitting ring portion 121 and the mounting chassis 11 are mutually interlocked and fixed, the flange ring portion 122 and the light-transmitting ring portion 121 are mutually interlocked and fixed, and the inner cover portion 123 is pressed onto the mounting chassis 11 by the flange ring portion 122, in this way, a complete cover assembly 12 is formed.

Further, at bottom portions of the housing mechanism 1 are provided supporting legs 111, and the supporting legs 111 are deployable or retractable relative to the housing mechanism 1, in the present embodiment, the supporting legs 111 are pivotally connected to the mounting chassis 11, and there are three supporting legs 111 distributed, on the mounting chassis 11 are provided slots for the supporting legs to be embedded in, and when the support legs 111 are in a stowed state, the support legs 111 are flush with the surface of the mounting chassis 11.

It should be noted that in the present embodiment, eight infrared sensors 3 are evenly distributed, an angle between two adjacent infrared sensors 3 is 45° and a detection angle of the infrared sensors 3 in a horizontal direction is theoretically 45°. However, in order to correct effects of assembly errors, component aging and placement angles, the detection angle of the infrared sensors 3 in a horizontal direction should be slightly larger than 45°, for example, it can be 46°-50°; a detection angle of the infrared sensor 3 in a vertical direction is 90°, so that the detection range of all infrared sensors 3 forms a hemisphere; and corresponding to the quantity of infrared sensors 3, eight detection indicators 21 are distributed on the main control circuit board 2.

The anti-sneak shot detector in the present embodiment has its function switch 24 defined to power on with a long two-second press, and to activate the function button 112 after a long two-second press. Correspondingly, a function indicator light 25 corresponding to a power indicator light is always on, the detection indicator lights 21 light up one by one, then all turn off after completing a cycle, so as to verify whether the detection indicator lights 21 are normal or not; open the support legs 111 to place the entire anti-sneak shot detector on the ground, table, bed, or any other flat surfaces; the start switch 23 is defined to initiate detection, the start button (1232) is pressed to cause each infrared sensor 3 to begin receiving infrared light individually or simultaneously. If the infrared sensors 3 are passive infrared sensors, infrared lights are only passively received; if the infrared sensors 3 are active infrared sensors, the infrared sensors 3 emit infrared rays outward and receive the infrared rays emitted back; when one or more infrared sensors 3 receive an infrared light, a corresponding detection indicator light 21 on the main control circuit board 2 responds by continuously flashing at a certain frequency, or, as shown in FIG. 5, the display screen 1233 responds with instructions in the direction of the infrared sensor, in the present embodiment, the intensity level of the infrared ray is displayed in a signal grid at the orientation of the infrared sensor, meanwhile, the sound generator 22 emits ten beeps, at this time, the approximate location of the hidden camera can be determined; if neither the detection indicator lights 21 nor the sound generator 22 respond, no hidden camera has been detected at that sensitivity level; short press the function switch 24 to switch to a close range detection mode, at this time, the sensitivity of the infrared sensors 3 is increased, but the detection distance is reduced, at the same time, the signal detection antenna 4 is activated and starts to receive wireless LAN signals; at this time, the user needs to hold the anti-sneak shot detector near the approximate location of the hidden camera to detect the number of lit detection indicator lights 21 or the strength level displayed on the display screen 1233, which changes according to the strength of the infrared and WLAN signals (the stronger the infrared and wireless LAN signals are, the more the detection indicator lights 21 are lit, and vice versa), until all detection indicator lights 21 are all bright and flashing, or the signal strength level displayed on the display screen 1233 is the maximum, and the sound generator 22 buzzes rapidly, which means that the hidden camera is very close.

The anti-sneak shot detector of the present embodiment is provided with a plurality of infrared sensors 3 uniformly distributed along the circumferential direction within the housing mechanism 1. The main control circuit board 2 is equipped with a plurality of detection indicator lights 21 which are arranged in a quantity and position corresponding to the infrared sensors 3. When any of the infrared sensors 3 receive an infrared light, a corresponding detection indicator light 21 on the main control circuit board (2) responds, which enables automated 360-degree environmental scanning to sweep for hidden cameras, provides excellent portability, makes it suitable for frequent travelers, individuals living alone, security personnel, and organizations dealing with sensitive information.

Although embodiments of the present invention have been shown and described, it will be apparent to those skilled in the art that various changes, modifications, substitutions, and alterations can be made to these embodiments without departing from the principles and spirit of the present invention. The scope of the present invention is defined by the appended claims and their equivalents.

1. An anti-sneak shot detector, comprising a housing mechanism, a main control circuit board, and infrared sensors, wherein
the housing mechanism at least comprises a light-transmitting ring portion capable of allowing infrared rays to pass through;
a plurality of the infrared sensors are evenly distributed in the housing mechanism along a circumferential direction, and receiving surfaces of the infrared sensors are aligned with the light-transmitting ring portion of the housing mechanism;
the main control circuit board is accommodated in the housing mechanism and is respectively connected to the infrared sensors via signals;
on the housing mechanism and/or the main control circuit board are provided indicators; and
when an infrared sensor receives an infrared signal, an indicator in a direction of the infrared sensor responds accordingly.

2. The anti-sneak shot detector according to claim 1, wherein on the main control board are provided a plurality of detection indicator lights which are arranged in a quantity and at positions corresponding to the infrared sensors, on the housing mechanism are provided a plurality of detection indication light-transmitting positions which are arranged in a quantity and at positions corresponding to the detection indicator lights on the main control circuit board; and
when an infrared sensor receives an infrared ray, a corresponding detection indicator light on the main control circuit board responds with instructions.

3. The anti-sneak shot detector according to claim 1, wherein the housing mechanism is embedded with a display screen, and the display screen is signally connected with the main control circuit board; and
when an infrared sensor receives an infrared ray, the display screen responds with instructions in a direction of the infrared sensor.

4. The anti-sneak shot detector according to claim 1, wherein the main circuit board is further provided with a sound generator; and
when an infrared sensor receives an infrared ray, the sound generator on the main control circuit board responds with instructions.

5. The anti-sneak shot detector according to claim 1 further comprising a signal detection antenna, wherein the signal detection antenna are accommodated in the housing mechanism, and is signally connected to the main control circuit board, or the signal detection antenna is mounted on the main control circuit board; and
when the signal detection antenna receives a communication signal, an indicator and/or the sounder generator responds with an indication correspondingly.

6. The anti-sneak shot detector according to claim 1 further comprising a battery, wherein the battery is accommodated in the housing mechanism and is electrically connected to the main control circuit board; and
the main control circuit board is also provided with a charging interface, and the charging interface penetrates from the housing mechanism.

7. The anti-sneak shot detector according to claim 1, wherein the main control circuit board is further provided with a start switch and a function switch respectively;
the housing mechanism is embedded with a start button which is aligned with the start switch on the main control circuit board, and when the start button is pressed, the start switch is triggered;
the housing mechanism is further embedded with a function button aligned with the function switch on the main control circuit board, and when the function button is pressed, the function switch is triggered.

8. The anti-sneak shot detector according to claim 7, wherein the main control circuit board is further provided with a plurality of function indicator lights; and
the housing mechanism are provided with a plurality of function indicator light-transmitting positions corresponding to a quantity and positions of the function indicator lights on the main control circuit board.

9. The anti-sneak shot detector according to claim 1, wherein the housing mechanism comprises a mounting chassis and a cover assembly which are combined together;
both the main control circuit board and the infrared sensors are fixed on the mounting chassis of the housing mechanism, and the cover assembly is covered on the mounting chassis to cover the main control circuit board and the infrared sensors;
the cover assembly comprises the light-transmitting ring portion, a flange ring portion, and an inner cover portion which are sequentially arranged from outside to inside;
display portions of the indicators are provided at where the inner cover portion locates; and
the light-transmitting ring portion and the mounting chassis are mutually interlocked and fixed, the flange ring portion and the light-transmitting ring portion are mutually interlocked and fixed, and the inner cover portion is pressed onto the mounting chassis by the flange ring portion.

10. The anti-sneak shot detector according to claim 1, wherein at bottom portions of the housing mechanism are provided supporting legs, and the supporting legs are deployable or retractable relative to the housing mechanism.

11. The anti-sneak shot detector according to claim 9, wherein at bottom portions of the housing mechanism are provided supporting legs, and the supporting legs are deployable or retractable relative to the housing mechanism.
